(19) United States
(12) Patent Application Publication
(10) Pub. No.: US 2007/0175390 A1
(43) Pub. Date: Aug. 2, 2007

(54) DOOR PAINTING BRACKET

(76) Inventor: THOMAS JOHN ALLEN, II, TWIN FALLS, ID (US)

Correspondence Address: DYKAS, SHAVER & NIPPER, LLP, P.O. BOX 877, BOISE, ID, 83701-0877, US

(21) Appl. No.: 11/560,221

(22) Filed: Nov. 15, 2006

Related U.S. Application Data
(60) Provisional application No. 60/737,075, filed on Nov. 15, 2005.

(51) Int. Cl. B05C 11/11

(52) U.S. Cl. 118/505

(57) ABSTRACT

A door bracket for holding stable and upright two or more doors for painting. The door bracket is formed of interconnecting arms which provide an end which is inserted in the door lock passage of the doors. A bracket of two arms can hold 2 to 3 doors upright, and a bracket of three arms can hold 3 or 4 doors upright while they are painted.

### FIELD OF THE INVENTION

Door holding brackets, and more particularly brackets for holding un-mounted doors upright, so that they can be painted or have finish applied.

### BACKGROUND OF THE INVENTION

The invention is a device for holding at least two doors in an upright position. Doors which are being prepared for installation in a new house are painted or treated with some other finish before they are installed. The paint is selected by the homeowner and is designed to match the other woodwork in the house. In a new house there can be quite a few doors that need to be painted, and putting them into a position in which they can be painted and left to dry becomes a time-consuming and labor intensive effort. When the doors are painted, they typically have been drilled for a doorknob, and have a hole drilled through the side of the door for the latch of the doorknob and have positions prepared to receive hinges. One way to lay out the doors for painting is to set up a number of saw horses, lay all the doors of the house on the saw horses, and paint one side of the door at a time. When the side that is painted is dried the doors can be flipped over, and the back side painted.

Another way that is currently used to paint doors for a house is to stand the doors upright and nail a piece of wood into the top of the door, and then nail the other end of the same piece of wood into the top of another door. In this way the two doors are held upright, and they are somewhat stable from falling over. However, this requires that a nail hole be placed in the top of the door, and if the doors are bumped they can easily fall down. If the two doors fall down they not only ruin the surface on the two doors, but they may also fall into other doors and ruin the painted surface on more than just the two doors.

What is needed is a device for holding unpainted doors upright which provides stability to the doors, and allows both sides of the two doors to be painted. Such a device needs to mount to the doors in a way that secures and stabilizes the doors, and does not require a nail or a screw to be placed in the door which would be seen later.

### SUMMARY OF THE INVENTION

These and other goals are accomplished by the door painting bracket of the invention. The device is a door stabilizer for holding doors needing painting in an upright position so they can be painted, and holding them upright while the paint dries. One version of the device is one made of two arms, a first arm and a second arm. The two arms are joined together and can be separable so that the arms can be separated from each other. Each of the arms has an end for insertion into the passage for the door latch of a door. The arms are not attached to the door, but serve to stabilize and hold the doors in an upright position.

One version of the device used square tubular material with square interconnecting links that join the two arms together. Another version uses three arms, and can be used to stabilize three or four doors in an upright position.

Another version of the device includes a bracket body, with a first arm and a second arm. Each arm has a hinge plate which is the same footprint as the hinge position on the doors, and fits in the hinge position and is screwed in place. The bracket body can have a third arm, and can thus stabilize three doors in an upright position.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the device of the invention in use with two doors.

FIG. 2 is a plan view of the device in use with two doors.

FIG. 3 is a perspective view of the first arm and the second arm of the device.

FIG. 4 is a perspective view of the first and second arm being fitted together.

FIG. 5 is a perspective view of the first and second arm fully fitted together.

FIG. 6 is a perspective view showing the first arm, second arm and third arm of the device fitted together.

FIG. 7 is a plan view of one version of the device showing the first arm, the second arm and the third arm in use with four doors.

FIG. 8 is a perspective view of the device showing three arms with each arm having a hinge plate.

FIG. 9 is a plan view of the device showing a two arm device with hinge plates attached to two doors.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

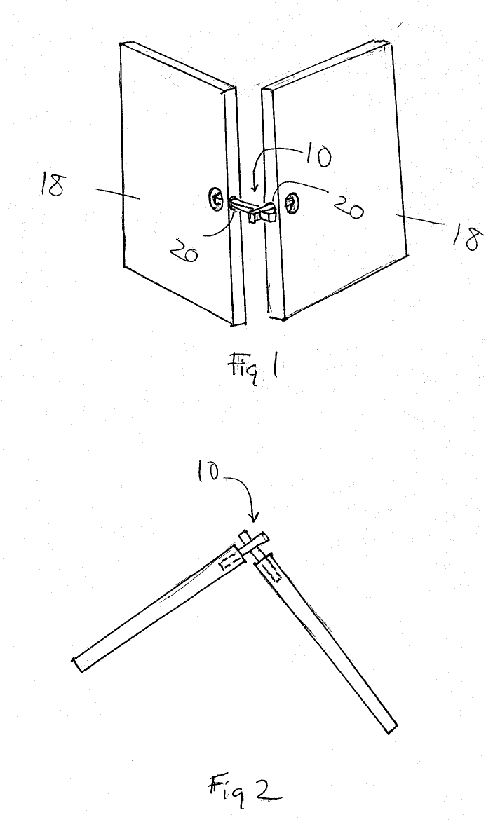

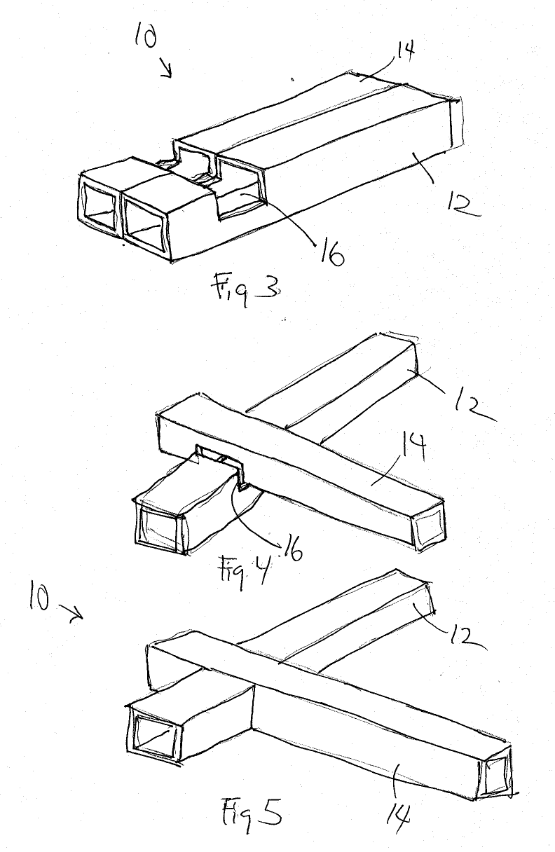

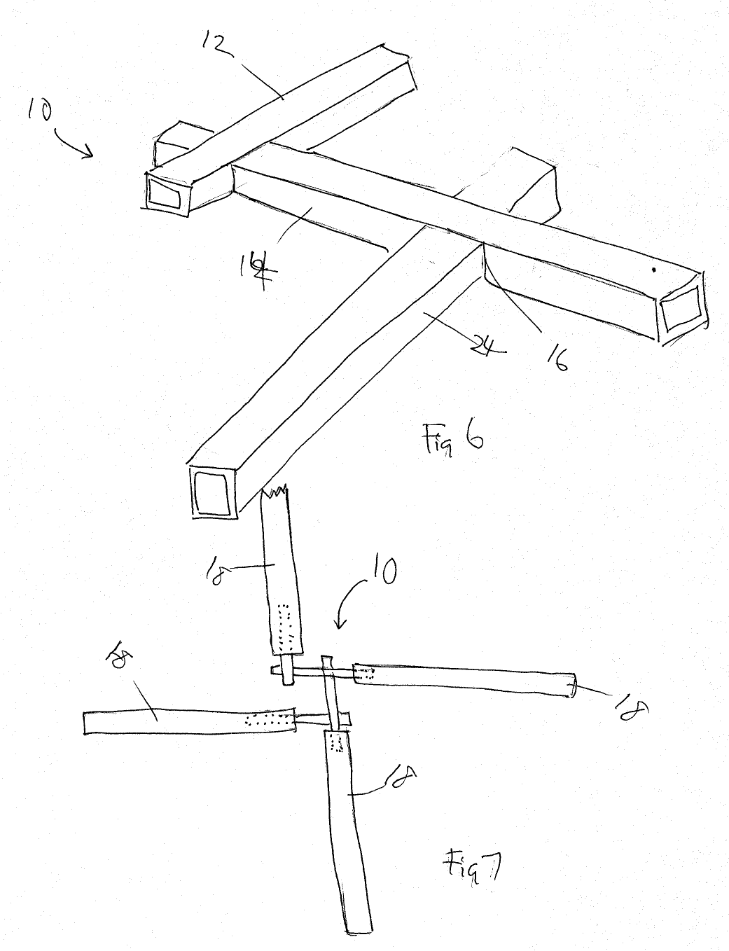

FIGS. 1 through 9 show several preferred embodiments of the invention. FIGS. 3 through 5 show an embodiment of the invention which is made up of a first arm 12 and a second arm 14. Looking at FIG. 3, the door bracket 10 includes a first arm 12 and a second arm 14. Each of the arms have an interconnecting notch 16. In this embodiment of the invention the first arm and second arm are made of a square tubular material, which can be metal or plastic. Aluminum tubing works well, and any metal or plastic could also be used. FIG. 4 shows the first arm 12 and the second arm 14 being joined together with the interconnecting notches 16 of each overlapping each other. FIG. 5 shows the door bracket 10 fully assembled with the first arm 12 and the second arm 14 fully joined together at their interconnecting notch. In this position, the two arms can only be disengaged by lifting one away from the other.

The device which is shown assembled in FIG. 5 is shown in use with doors 18 in FIG. 1. In FIG. 1 the door bracket 10 is inserted into the door latch passage 20 of each of these doors. In this configuration the doors are stabilized for standing upright with no other supports. In this position both sides of the door and all around the outside edge of the door except the bottom edge may be painted or sprayed with some other finish such as stain, sealant, varnish or covering such as varethane. FIG. 2 is a top view of the same two door arrangement, with the device 10 in place in the door latch passages 20, and with the doors stabilized for free-standing in a spaced apart positioned. In this position the doors can't fall down unless the door bracket 10 is broken.

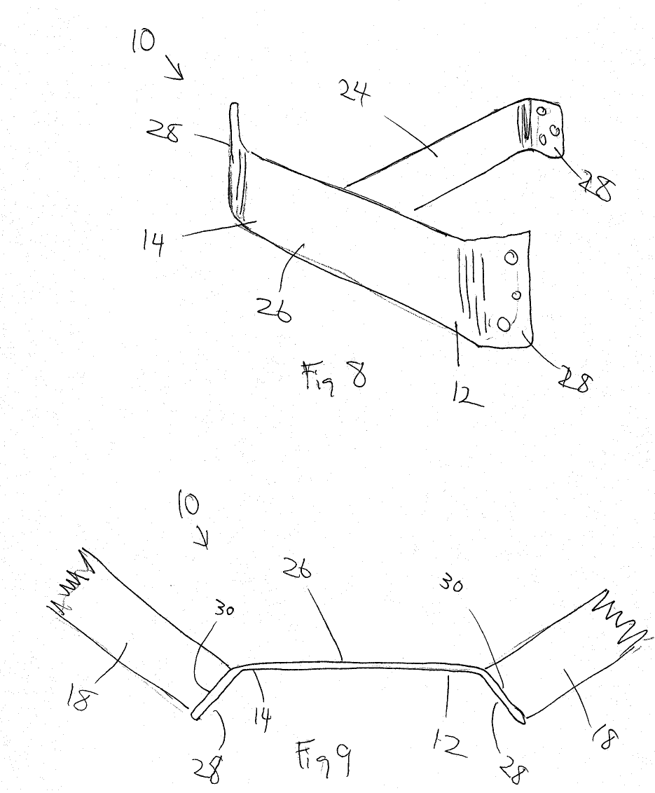

FIG. 6 shows another version of the door bracket 10 which includes a first arm 12 a second arm 14 and a third arm 24. These arms can be connected as was shown in FIGS. 3-5, by the use of interconnecting notches 16 on each of the doors. FIG. 7 shows the door bracket 10 of FIG. 6 attached to four doors 18. In this position, the doors 18 are stable and will remain free standing unless the door bracket 10 is broken.

FIG. 8 shows another embodiment of the invention which includes a bracket body 26. The bracket body 26 is made up of a first arm 12, a second arm 14, and in this case, a third arm 24. At the end of each of the arms is a hinge plate 28. The hinge plate 28 on each of these arms is configured to fit the hinge plate area and the hinge screw holes of a door. FIG. 9 is a plan view showing the device with a bracket body 26, a first arm 12, a second arm 14, hinge plates 28 attached to the door hinge position 30 on doors 18. The door bracket of this configuration can be made from aluminum, steel, plastic, or any suitable material.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

I claim:

1. A device for holding doors upright for painting, in which the doors to be painted include a doorknob passage and a door latch passage, comprising;
a first arm for inserting into said door latch passage in a first door, for stabilizing said first door in an upright position;
a second arm attachable to said first arm, for inserting into said door latch passage in a second door, for stabilizing said second door in an upright position, with said second arm attachable to said first arm at a predetermined angle; wherein
said device is capable of stabilizing two doors so that they may be painted while in an upright position and connected position.

2. The device of claim 1 in which the first arm and second arm are configured to be separable and attachable to each other.

3. The device of claim 2 in which the first arm and second arm separably attach to each other by an interlocking connection, without use of bolts or screws or tools.

4. The device of claim 3 in which the interlocking connection comprises a notch in the first arm which interfits with a notch in the second arm.

5. The device of claim 3 in which said first and second arms are generally square tubular in cross section and said notches form a square cut in said square tubular first and second arms.

6. The device of claim 1 in which the angle between the first and second arms is fixed.

7. The device of claim 6 in which the angle between arms is about 90 degrees.

8. The device of claim 1 which further includes a third arm, attached to said first or second arm, which projects at an angle roughly perpendicular to the arm to which it attaches.

9. The device of claim 7 in which the first arm, second arm and third arm separably attach to each other by an interlocking connection.

10. The device of claim 8 in which the interlocking connection comprises a notch for each connection between arms.

11. The device of claim 7 in which the angle between arms is about 90 degrees.

12. A device for holding doors upright for painting, in which the doors to be painted include a doorknob passage and a door latch passage, comprising;
a generally square tubular first arm for inserting into said door latch passage in a first door, for stabilizing said first door in an upright position, with said first arm comprising an interconnecting notch;
a generally square tubular second arm with an interconnecting notch, separately attachable to said first arm by jointing the arms at the interconnecting notches of each, said second arm for inserting into said door latch passage in a second door, for stabilizing said second door in an upright spaced apart position with said second arm attachable to said first arm at a predetermined angle; wherein
said device is capable of stabilizing two doors so that they may be painted while in an upright position and connected and spaced apart position.

13. A device for holding doors upright for painting, in which the doors to be painted include a plurality of hinge positions, comprising;
a bracket body, comprising:
a first arm with a hinge plate for attachment to a hinge position on a first door; for stabilizing said first door in an upright position, with said first arm attached to said bracket body; and
a second arm with a hinge plate for attachment to a hinge position on a second door, for stabilizing said second door in an upright position, with said second arm to said bracket body; attachable to said first arm at a predetermined angle; wherein
said device is capable of stabilizing two doors in a vertical and spaced apart and connected position, so that they may be painted.

14. The device of claim 1 which further includes a third arm with a hinge plate attachment, attached to said bracket body, which projects at an angle from the arm to which it attaches, for attachment to a hinge plate position on a third door, for stabilizing said third door in a vertical and spaced apart and connected position for painting.
